(19) United States
(12) Patent Application Publication
(10) Pub. No.: US 2026/0093110 A1
(43) Pub. Date: Apr. 2, 2026

(54) OBJECTIVE

(71) Applicant: Evident Corporation, Tatsuno-machi, Kamiina-gun, Nagano (JP)

(72) Inventor: Kengo OSAWA, Kamiina-gun (JP)

(73) Assignee: Evident Corporation, Tatsuno-machi, Kamiina-gun, Nagano (JP)

(21) Appl. No.: 19/336,568

(22) Filed: Sep. 23, 2025

(30) Foreign Application Priority Data
Sep. 30, 2024 (JP) 2024-170339

(51) Int. Cl. G02B 27/00; G02B 9/64

(52) U.S. Cl. CPC G02B 27/0025; G02B 9/64

(57) ABSTRACT

An objective includes, in order from an object side: a first lens group having positive refractive power and including three or more lens components; a second lens group having a highest light ray height and moving on an optical axis; a third lens group including a lens component having a concave surface facing an image side and closest to the image side of the third lens group; and a fourth lens group including a lens component having a concave surface facing an object side and closest to the object side of the fourth lens group, in which the first lens group includes a cemented lens closer to the image side than the lens component closest to the object side of the first lens group.

### CROSS-REFERENCE TO RELATED APPLICATION

This application is based upon and claims the benefit of priority from prior Japanese Patent Application No. 2024-170339, filed Sep. 30, 2024, the entire contents of which are incorporated herein by this reference.

### FIELD OF DISCLOSURE

The disclosure of the present specification relates to an objective.

### BACKGROUND

In recent years, studies using cell aggregates such as spheroids and organoids obtained by collecting and three-dimensionally culturing a large number of cells have attracted attention. Since such a sample has a size of, for example, about 100 μm to 500 μm, an immersion objective is generally used for observation of deep cells.

The immersion objective can have a higher numerical aperture than that of a dry objective when the space between the objective and the sample (more specifically, a holding member holding the sample) is filled with an immersion liquid, and thereby performing bright observation with high resolution. In addition, by using the immersion liquid having a refractive index close to the refractive index of the sample, it is also possible to suppress spherical aberration caused by a refractive index mismatch occurring at the interface between the sample and the immersion liquid. The effect of the spherical aberration caused by the refractive index mismatch becomes more pronounced as the observation position becomes deeper, so that it is possible to observe up to a deeper position by suppressing the spherical aberration.

### SUMMARY

An objective according to one aspect of the present invention includes, in order from an object side: a first lens group having positive refractive power and including three or more lens components; a second lens group having a highest light ray height and moving on an optical axis; a third lens group including a lens component having a concave surface facing an image side and closest to the image side of the third lens group; and a fourth lens group including a lens component having a concave surface facing an object side and closest to the object side of the fourth lens group, in which the first lens group includes a cemented lens closer to the image side than the lens component closest to the object side of the first lens group.

### BRIEF DESCRIPTION OF THE DRAWINGS

FIG. 1 is a cross-sectional view of an objective according to a first example of the present invention;

FIG. 2 is a cross-sectional view of an imaging lens;

FIGS. 3A to 3D are aberration diagrams of an optical system including the objective and the imaging lens in a first state;

FIGS. 4A to 4D are aberration diagrams of the optical system including the objective and the imaging lens in a second state;

FIG. 5 is a cross-sectional view of an objective according to a second example of the present invention;

FIGS. 6A to 6D are aberration diagrams of an optical system including the objective and the imaging lens in a first state; and

FIGS. 7A to 7D are aberration diagrams of an optical system including the objective and the imaging lens in a second state.

### DETAILED DESCRIPTION

A long working distance is required to observe the sample deeply. U.S. Pat. No. 10,732,395 describes an immersion objective for a microscope with a long working distance. However, the numerical aperture is slightly small, and there is room for improvement in chromatic aberration performance. Therefore, an objective having a long working distance, a higher numerical aperture, and excellent aberration performance is desired.

An objective according to an embodiment of the present application will be described. The objective according to the present embodiment (simply referred to as an objective below) is an infinity-corrected microscope objective used in combination with an imaging lens. In the present specification, the lens component refers to a single lens block in which only two surfaces that are a surface on an object side and a surface on an image side among lens surfaces through which a light ray from an object point passes have contact with air regardless of whether the lens is a single lens or a cemented lens. In other words, one single lens is one lens component, and one cemented lens is also one lens component. On the other hand, a plurality of single lenses and a plurality of cemented lenses arranged with air therebetween are not referred to as one lens component herein. In addition, the meniscus lens component refers to a lens component having a meniscus lens shape, and refers to a lens component in which one of a surface closest to the object side and a surface closest to the image side of the lens component is a concave surface and the other is a convex surface.

The objective includes a first lens group having positive refractive power, a second lens group, a third lens group, and a fourth lens group, which are disposed in order from an object side. The first lens group includes three or more lens components, and includes a cemented lens on the image side of the lens component closest to the object side. The second lens group is a moving group that moves along the optical axis and is disposed at a position where the light ray height is greatest. The third lens group includes a lens component having a concave surface facing the image side closest to the image side in the third lens group. The fourth lens group includes a lens component having a concave surface facing the object side closest to the object side in the fourth lens group. That is, the third lens group and the fourth lens group are disposed with their concave surfaces facing each other.

In the objective configured as described above, since the first lens group includes three or more lens components, divergent light from an object point can be gently converged by the first lens group. For this reason, it is possible to suppress the occurrence of spherical aberration and coma aberration. Further, since the first lens group includes the cemented lens in the region on the image side with respect to the lens component on a side closest to the object side where both the off-axis chief light ray and the marginal light ray are high, it is possible to mainly correct both the axial chromatic aberration and the lateral chromatic aberration by the cemented lens.

In addition, in the above described objective, by arranging the second lens group after the first lens group having positive refractive power, light enters the second lens group with divergence of light from the object point mitigated. In addition, by configuring the second lens group having the highest marginal light ray height as a moving group that moves in the optical axis direction, it is possible to greatly vary the marginal light ray height passing through the second lens group and to sufficiently change the amount of occurrence of spherical aberration. Therefore, by the movement of the second lens group, spherical aberration caused by changes in observation depth and the like can be effectively corrected.

In addition, in the objective, the light having passed through the second lens group is converted into parallel light while well correcting various aberrations by the third lens group and the fourth lens group. Here, by adopting a form in which the surface closest to the image side of the third lens group and the surface closest to the object side of the fourth lens group face the concave surfaces (so-called Gaussian group optical system), the marginal light height ray can be reduced in the concave surfaces facing each other. Therefore, the Petzval sum can be effectively corrected, and the field curvature can be satisfactorily reduced.

According to the objective configured as described above, it is possible to achieve good aberration performance while achieving a long working distance and high NA. A desirable configuration of the objective will be described below.

It is desirable that the first lens group include a cemented lens including a positive lens having a convex surface facing the image side and a meniscus lens having a concave surface facing the object side, on a side closest to the object side. This configuration makes it possible to favorably correct the field curvature. More specifically, by imparting a refraction action by the concave surface of the meniscus lens at the cemented surface of the lens component on a side closest to the object side where light emitted from the object point is incident before the marginal light ray height increases, it is possible to effectively correct the Petzval sum.

It is desirable that the first lens group include a three-lens cemented lens, and in particular, it is desirable that the cemented lens arranged in the region on the image side than the lens component on a side closest to the object side is a three-lens cemented lens. As described above, both the off-axis chief light ray and the marginal ray are high in the region on the image side of the first lens group. Therefore, by arranging the three-lens cemented lens in the region, it is possible to mainly correct both the axial chromatic aberration and the lateral chromatic aberration.

It is desirable that the second lens group include the two-lens cemented lens. By using the two-lens cemented lens for the second lens group having the highest marginal light ray, axial chromatic aberration can be corrected greatly in addition to spherical aberration.

It is desirable that the third lens group include a single lens component. This makes it possible to avoid an increase in manufacturing cost caused by the third lens group including the plurality of lens components.

It is desirable that the fourth lens group include a meniscus lens component having a concave surface facing the object side on the image side of a lens component having a concave surface facing the object side, which is a lens component arranged closest to the object side of the fourth lens group. Consequently, lateral chromatic aberration, astigmatism, and coma aberration can be corrected more favorably in a wide wavelength range. This will be described in more detail below. In the fourth lens group arranged closest to the image side, it is preferable to arrange a lens pair having different dispersion characteristics in order to correct the lateral chromatic aberration. However, when the lens pair is cemented, coma aberration and astigmatism occurring on the cemented surface are different between wavelengths, and a difference occurs therebetween. Therefore, the fourth lens group includes a lens component that plays a role of an image side portion of the Gaussian group and one or more lens components arranged via an air surface. Consequently, air interfaces of one pair or more can be provided in addition to the correction action of the Petzval sum of the above-described facing concave surfaces, it is possible to favorably correct astigmatism or coma aberration by differentiating the refraction angle or the light ray height of the off-axis light ray at the surfaces. In particular, since the one or more lens components include a meniscus lens component having a concave surface facing the object side, it is possible to gently refract light before the light ray height becomes high as compared with a planoconvex lens or a biconvex lens, and thus, it is possible to suppress the occurrence of aberrations such as coma aberration and astigmatism particularly caused by off-axis performance. As a result, lateral chromatic aberration, astigmatism, and coma aberration can be corrected more favorably in a wide wavelength range.

It is desirable that the objective be configured to satisfy the following conditional expression (1). Here, δ is a distance on the optical axis between a lens component with a concave surface facing the object side and a meniscus lens component with a concave surface facing the object side, which are included in the fourth lens group. D is a distance (hereinafter, also referred to as an optical length) on the optical axis from a specimen surface to a lens surface on a side closest to the image side of the fourth lens group. Note that the specimen surface is a surface including a condensing position when an infinite light flux is incident on the objective from the image side, that is, a front focal position.

$$0.002 \leq δ / D \leq 0 \text{.02} \qquad ( 1 )$$

The conditional expression (1) mainly defines an air spacing between a lens component disposed closest to the object side and a meniscus lens component having a concave surface facing the object side in the fourth lens group. By satisfying the conditional expression (1), mainly the Petzval sum can be corrected well. More specifically, by setting the air spacing between meniscus lens component and the lens component with the concave surface facing the object side in the fourth lens group so that δ/D is equal to or greater than the lower limit value, it is possible to avoid interference between the lenses without setting the tolerance of each part to be narrow. In addition, by narrowing the air spacing between the meniscus lens component and the lens component with the concave surface facing the object side in the fourth lens group so that δ/D is equal to or less than the upper limit value, it is possible to sufficiently increase the thickness of the lens component with the concave surface facing the object side constituting the Gaussian group while satisfying a predetermined overall length of the objective. Therefore, the Petzval correction function can be sufficiently provided.

It is desirable that the fourth lens group have negative refractive power. By setting the fourth lens group to have negative refractive power, it is possible to design a marginal light ray at the time of incidence from the third lens group to the fourth lens group to be low. Therefore, the Petzval sum can be effectively corrected on the concave surfaces of the third lens group and the fourth lens group facing each other, and the field curvature can be sufficiently reduced.

It is desirable that the third lens group and the fourth lens group each include a cemented lens. In the third lens group, the marginal light ray height becomes high. Therefore, the axial chromatic aberration can be effectively corrected by including the cemented lens in the third lens group. In addition, in the fourth lens group, the off-axis chief light ray height is also high in addition to the marginal light ray height. Therefore, in addition to the axial chromatic aberration, the lateral chromatic aberration can also be effectively corrected by including the cemented lens in the fourth lens group. When both lens groups include the cemented lens, axial and off-axis chromatic aberrations can be more effectively corrected.

In the objective configured as described above, it is desirable that spherical aberration can be corrected by the movement of the second lens group to a position corresponding to the immersion liquid having a refractive index of 1.33 to 1.40. Since the spherical aberration can be corrected using the immersion liquid having the refractive index from 1.33 corresponding to water to 1.40 corresponding to silicone oil, it is possible to favorably correct the spherical aberration amount that can greatly vary due to the difference in the refractive index of the immersion liquid.

In addition, in the objective, it is desirable that spherical aberration can be corrected by the movement of the second lens group to a position corresponding to the immersion liquid having a refractive index of 1.33 to 1.40, and that the objective be configured so that the following conditional expressions (2) and (3) be satisfied. Herein, f is a focal length of the objective. NA is a numerical aperture on the object side of the objective. WD is the working distance of the objective.

$$D / f \leq 7 \qquad ( 2 )$$

$$D / ( {NA}^{2} \cdot WD ) \leq 35 \qquad ( 3 )$$

The conditional expression (2) defines the relationship between the focal length and the optical length. The conditional expression (3) defines the relationship between the optical length, the numerical aperture, and the working distance. Since the objective satisfies the conditional expression (2) that substantially limits the overall length and further satisfies the conditional expression (3), it is possible to provide an objective having a required working distance and numerical aperture while suppressing the overall length of the objective within a predetermined range.

Hereinafter, examples of the objective described above will be described in detail.

### First Example

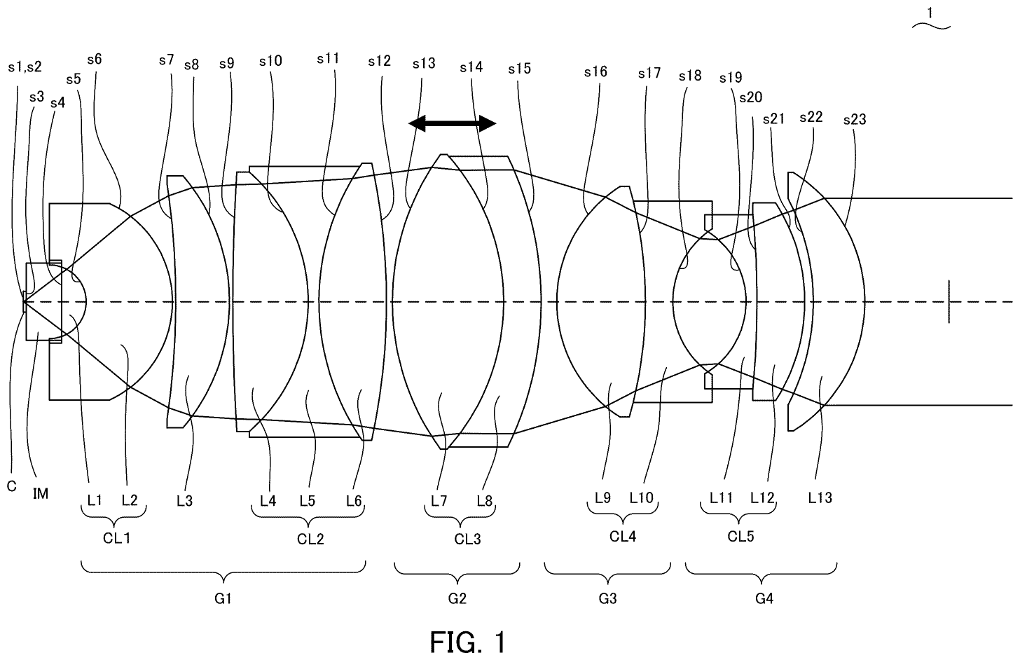

FIG. 1 is a cross-sectional view of an objective 1 according to the present example. The objective 1 is an immersion objective for microscopes. The objective 1 includes, in order from the object side, a first lens group G1 having positive refractive power, a second lens group G2, and a third lens group G3, and a fourth lens group G4. A space between the first lens group G1 and a cover glass C is filled with an immersion liquid IM.

The first lens group G1 includes, in order from the object side, a cemented lens CL1, a lens L3 that is a meniscus lens having a concave surface facing the object side, and a cemented lens CL2. The cemented lens CL1 is a two-lens cemented lens in which a lens L1 that is a positive lens having a convex surface facing the image side and a lens L2 that is a meniscus lens having a concave surface facing the object side are cemented. The cemented lens CL2 is a three-lens cemented lens in which a lens L4 that is a biconvex lens, a lens L5 that is a biconcave lens, and a lens L6 that is a biconvex lens are cemented.

The second lens group G2 includes a cemented lens CL3 that moves on the optical axis. The cemented lens CL3 is a two-lens cemented lens in which a biconvex lens L7 and a meniscus lens L8 having a concave surface facing the object side are cemented.

The third lens group G3 includes a cemented lens CL4. The cemented lens CL4 is a two-lens cemented lens in which a biconvex lens L9 and a biconcave lens L10 are cemented.

The fourth lens group G4 includes, in order from the object side, a cemented lens CL5, and a lens L13 that is a meniscus lens (a meniscus lens component) having a concave surface facing the object side. The cemented lens CL5 is a two-lens cemented lens in which a lens L11 that is a meniscus lens having a concave surface facing the object side and a lens L12 that is a meniscus lens having a concave surface facing the object side are cemented.

Various types of data of the objective 1 are as follows. Note that f, f_{G1}, f_{G2}, f_{G3}, f_{G4}, n₀, v₀ are the focal length of the objective 1, the focal length of the first lens group G1, the focal length of the second lens group G2, the focal length of the third lens group G3, the focal length of the fourth lens group G4, the refractive index of the immersion liquid IM, and the Abbe number of the immersion liquid IM, respectively. The reference wavelength is the d-line. Note that, in the present embodiment, silicone oil and water are used as the immersion liquid IM. Note that f_{G1}, f_{G2}, f_{G3}, f_{G4}, δ do not change between the case of using silicone oil as the immersion liquid IM and the case of using water as the immersion liquid IM. On the other hand, f, WD and D can be changed by the immersion liquid IM, and thus are disclosed for each immersion liquid IM.
f_{G1}=9.797 mm, f_{G2}=22.926 mm, f_{G3}=−22.135 mm, f_{G4}=−139.849 mm, δ=0.504 mm
(in a case where the immersion liquid IM is a silicone oil (n₀=1.40410, v₀=51.90))
f=7.212 mm, NA=0.85, WD=2.100 mm, D=50.026 mm
(in a case where the immersion liquid IM is water (n₀=1.33304, v₀=55.79))
f=7.407 mm, NA=0.85, WD=2.030 mm, D=49.957 mm

Lens data of the objective 1 is as follows. Note that the INF in the lens data indicates infinity (∞).

Objective Lens 1

| s | r | d | nd | vd |
|---|---|---|---|---|
| 1 | INF | 0 | n₀ | v₀ |
| 2 | INF | 0.17 | 1.52344 | 54.40 |
| 3 | INF | WD | n₀ | v₀ |
| 4 | INF | 1.464 | 1.51633 | 64.14 |
| 5 | −2.1846 | 5.129 | 1.88300 | 40.76 |
| 6 | −6.4173 | 0.200 | | |
| 7 | −47.6119 | 3.189 | 1.80400 | 46.53 |
| 8 | −11.5195 | 0.200 | | |
| 9 | 124.3531 | 4.487 | 1.56907 | 71.30 |
| 10 | −10.2048 | 0.636 | 1.63775 | 42.41 |
| 11 | 14.4760 | 4.017 | 1.43875 | 94.66 |
| 12 | −38.7728 | D1 | | |
| 13 | 14.8086 | 6.611 | 1.43875 | 94.66 |
| 14 | −13.0671 | 2.232 | 1.63775 | 42.41 |
| 15 | −19.7676 | D2 | | |
| 16 | 8.1172 | 5.269 | 1.43875 | 94.66 |
| 17 | −25.0635 | 1.629 | 1.63775 | 42.41 |
| 18 | 5.1825 | 4.353 | | |
| 19 | −4.9512 | 0.652 | 1.73800 | 32.33 |
| 20 | −54.8305 | 2.839 | 1.60300 | 65.44 |
| 21 | −10.8096 | 0.504 | | |
| 22 | −13.3289 | 3.067 | 1.85478 | 24.80 |
| 23 | −9.0513 | 110.000 | | |

Here, s indicates a surface number, r indicates a radius of curvature (mm), d indicates a surface spacing (mm), nd indicates a refractive index, and vd indicates an Abbe number. Note that the reference wavelength is the d-line (587.56 nm). These symbols are similar in the following examples. Note that both surfaces indicated by surface numbers s1 and s2 are object-side surfaces of a cover glass CG and a surface indicated by a surface number s3 is an image-side surface of the cover glass CG. Surfaces indicated by surface numbers s4 and s23 are a lens surface of the objective 1 that is closest to the object side and a lens surface of the objective 1 that is closest to the image side, respectively. In addition, for example, the surface spacing d1 indicates a distance on the optical axis from the surface indicated by the surface number s1 to the surface indicated by the surface number s2. Note that the surface spacing d23 indicates a distance on the optical axis from the surface indicated by the surface number s23 to the imaging lens, and is 110 mm although omitted on the lens data.

When a state in which the second lens group is moved corresponding to the silicone oil as the immersion liquid IM is defined as a first state and a state in which the second lens group is moved corresponding to the water as the immersion liquid IM is defined as a second state, D1 and D2, which are values (unit: mm) of the spacings d12 and d15 in the lens data in each state, and various parameters are as follows.

First State and Second State

| | | |
|---|---|---|
| n₀ | 1.40410 | 1.33304 |
| v₀ | 51.90 | 55.79 |
| WD | 2.100 | 2.030 |
| f | 7.212 | 7.407 |
| D1 | 0.350 | 0.933 |
| D2 | 0.931 | 0.348 |

The objective 1 satisfies conditional expressions (1) to (3) in both the first and second states, as described below.

$$( First state ) δ / D = 0 \text{.010} \qquad ( 1 )$$

$$( Second state ) δ / D = 0.0 \; 10 \qquad ( 1 )$$

$$( First state ) D / f = 6.9 \; 37 \qquad ( 2 )$$

$$( Second state ) D / f = 6.7 \; 45 \qquad ( 2 )$$

$$( First state ) D / ( {NA}^{2} \cdot WD ) = 32.9 \; 72 \qquad ( 3 )$$

$$( Second state ) D / ( {NA}^{2} \cdot WD ) = 34.063 \qquad ( 3 )$$

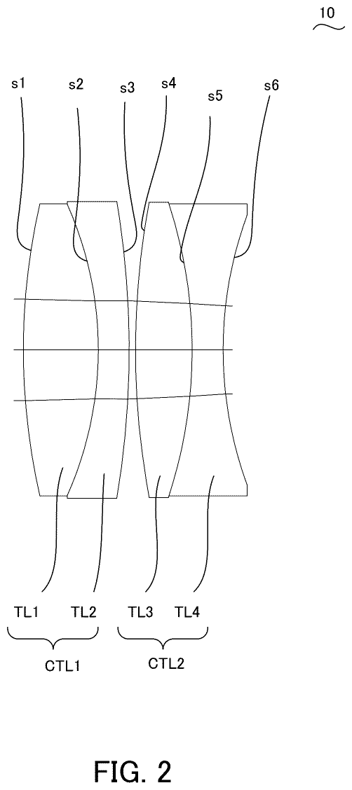

FIG. 2 is a cross-sectional view of an imaging lens 10 used in combination with the objective 1. The imaging lens 10 is a microscope imaging lens that forms an enlarged image of an object in combination with the infinity-corrected objective. The imaging lens 10 includes, in order from the object side, a cemented lens CTL1 and a cemented lens CTL2. The cemented lens CTL1 is a two-lens cemented lens including a lens TL1 that is a biconvex lens and a lens TL2 that is a meniscus lens having a concave surface facing the object side. The cemented lens CTL2 is a two-lens cemented lens including a lens TL3 that is a biconvex lens and a lens TLA that is a biconcave lens. Note that a focal length ft of the imaging lens 10 is 180 mm.

Lens data of the imaging lens 10 is as follows.

Imaging Lens 10

| s | r | d | nd | vd |
|---|---|---|---|---|
| 1 | 68.7541 | 7.7321 | 1.48749 | 70.21 |
| 2 | −37.5679 | 3.4742 | 1.80610 | 40.95 |
| 3 | −102.8477 | 0.6973 | | |
| 4 | 84.3099 | 6.024 | 1.83400 | 37.17 |
| 5 | −50.7100 | 3.030 | 1.64450 | 40.82 |
| 6 | 40.6619 | 9.038 | | |

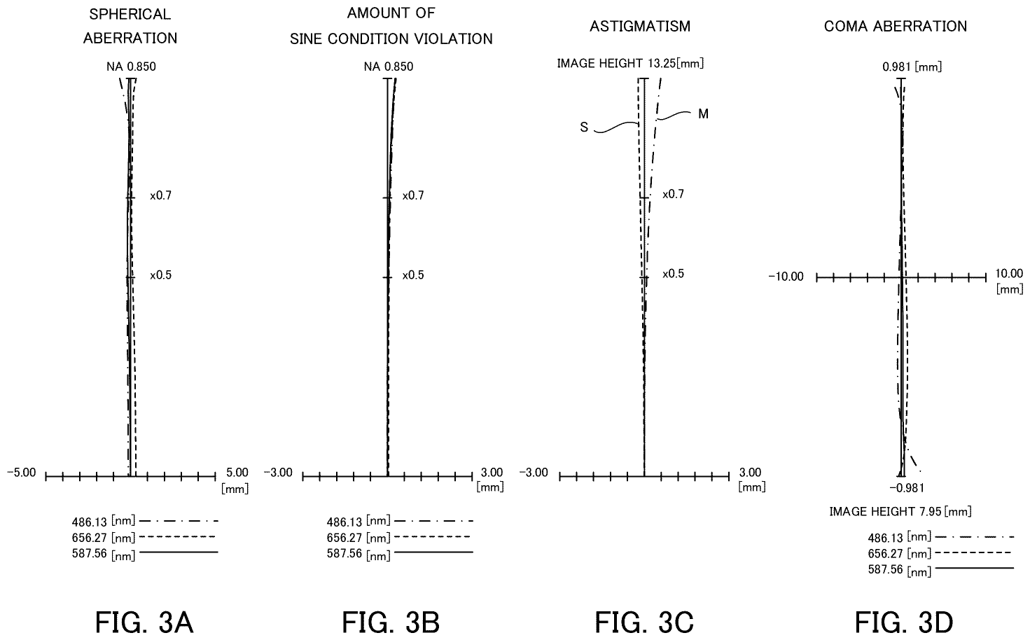

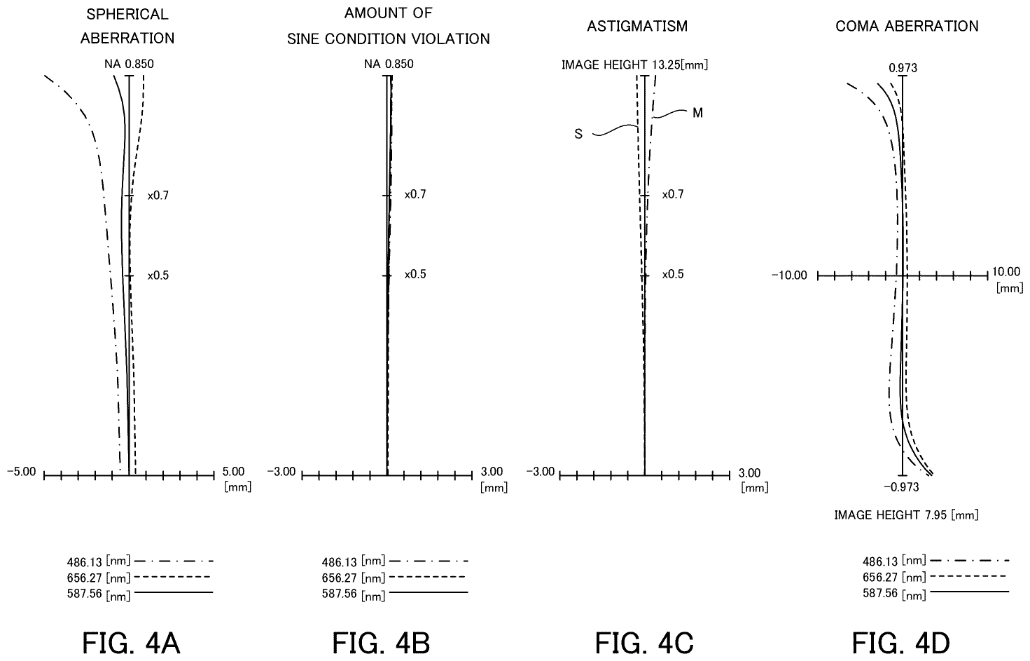

FIGS. 3 and 4 are aberration diagrams of the optical system including the objective 1 and the imaging lens 10, and illustrate aberrations on an image surface on which the objective 1 and the imaging lens 10 are formed, in the first state and the second state, respectively. FIGS. 3A and 4A are diagrams of spherical aberrations. FIGS. 3B and 4B are diagrams illustrating the amounts of sine condition violation. FIGS. 3C and 4C are astigmatism diagrams. FIGS. 3D and 4D are diagrams illustrating coma aberrations at an image height ratio of 0.6 (image height of 7.95 mm). Note that, in the drawings, “M” indicates a meridional component, and “S” indicates a sagittal component. As illustrated in FIGS. 3 and 4, in the present example, the aberration is favorably corrected regardless of the immersion liquid.

### Second Example

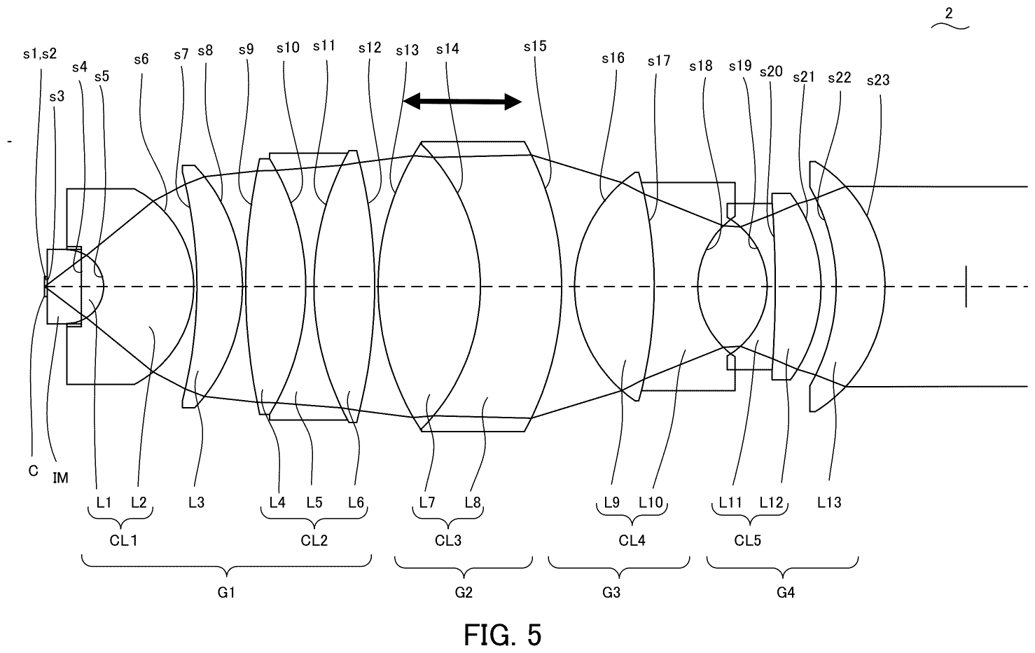

FIG. 5 is a cross-sectional view of an objective 2 according to the present example. The objective 2 is an immersion objective for microscopes. The objective 2 includes, in order from the object side, a first lens group G1 having positive refractive power, a second lens group G2, and a third lens group G3, and a fourth lens group G4. A space between the first lens group G1 and a cover glass C is filled with an immersion liquid IM.

The first lens group G1 includes, in order from the object side, a cemented lens CL1, a lens L3 that is a meniscus lens having a concave surface facing the object side, and a cemented lens CL2. The cemented lens CL1 is a two-lens cemented lens in which a lens L1 that is a positive lens having a convex surface facing the image side and a lens L2 that is a meniscus lens having a concave surface facing the object side are cemented. The cemented lens CL2 is a three-lens cemented lens in which a lens L4 that is a biconvex lens, a lens L5 that is a biconcave lens, and a lens L6 that is a biconvex lens are cemented.

The second lens group G2 includes a cemented lens CL3 that moves on the optical axis. The cemented lens CL3 is a two-lens cemented lens in which a biconvex lens L7 and a meniscus lens L8 having a concave surface facing the object side are cemented.

The third lens group G3 includes a cemented lens CL4. The cemented lens CL4 is a two-lens cemented lens in which a biconvex lens L9 and a biconcave lens L10 are cemented.

The fourth lens group G4 includes, in order from the object side, a cemented lens CL5, and a lens L13 that is a meniscus lens (meniscus lens component) having a concave surface facing the object side. The cemented lens CL5 is a two-lens cemented lens in which a lens L11 that is a meniscus lens having a concave surface facing the object side and a lens L12 that is a meniscus lens having a concave surface facing the object side are cemented.

Various types of data of the objective 2 are as follows.
f_{G1}=10.002 mm, f_{G2}=23.436 mm, f_{G3}=−21.584 mm, f_{G4}=−139.219 mm, δ=0.931 mm
(in a case where the immersion liquid IM is a silicone oil (n₀=1.40410, v₀=51.90))
f=7.214 mm, NA=0.85, WD=2.100 mm, D=50.074 mm
(in a case where the immersion liquid IM is water (n₀=1.33304, v₀=55.79))
f=7.399 mm, NA=0.85, WD=2.032 mm, D=50.007 mm

Lens data of the objective 2 is as follows.

Objective Lens 2

| s | r | d | nd | vd |
|---|---|---|---|---|
| 1 | INF | 0 | n₀ | v₀ |
| 2 | INF | 0.17 | 1.52344 | 54.40 |
| 3 | INF | WD | n₀ | v₀ |
| 4 | INF | 1.366 | 1.51633 | 64.14 |
| 5 | −2.2639 | 5.540 | 1.88300 | 40.76 |
| 6 | −6.7611 | 0.200 | | |
| 7 | −28.0949 | 2.798 | 1.80400 | 46.53 |
| 8 | −10.9119 | 0.200 | | |
| 9 | 36.1770 | 3.699 | 1.43875 | 94.66 |
| 10 | −14.9013 | 0.500 | 1.63775 | 42.41 |
| 11 | 17.2064 | 3.737 | 1.43875 | 94.66 |
| 12 | −31.8767 | D1 | | |
| 13 | 16.0358 | 6.288 | 1.43875 | 94.66 |
| 14 | −12.3571 | 3.374 | 1.63775 | 42.41 |
| 15 | −18.4540 | D2 | | |
| 16 | 8.4646 | 4.896 | 1.43875 | 94.66 |
| 17 | −26.2350 | 2.679 | 1.63775 | 42.41 |
| 18 | 5.1972 | 4.267 | | |
| 19 | −4.9189 | 0.505 | 1.73800 | 32.33 |
| 20 | −66.2573 | 2.811 | 1.60300 | 65.44 |
| 21 | −9.6525 | 0.931 | | |
| 22 | −12.3167 | 3.001 | 1.85478 | 24.80 |
| 23 | −9.0209 | 110.000 | | |

D1, D2, and various parameters which are values (unit: mm) of the spacings d12 and d15 in the lens data in the first state and the second state, are as follows.

First State and Second State

| | | |
|---|---|---|
| n₀ | 1.40410 | 1.33304 |
| v₀ | 51.90 | 55.79 |
| WD | 2.100 | 2.032 |
| f | 7.214 | 7.399 |
| D1 | 0.214 | 0.772 |
| D2 | 0.800 | 0.242 |

The objective 2 satisfies conditional expressions (1) to (3) in both the first and second states, as described below.

$$( First state ) δ / D = 0 \text{.019} \qquad ( 1 )$$

$$( Second state ) δ / D = 0.0 \; 19 \qquad ( 1 )$$

$$( First state ) D / f = 6.9 \; 42 \qquad ( 2 )$$

$$( Second state ) D / f = 6.7 \; 59 \qquad ( 2 )$$

$$( First state ) D / ( {NA}^{2} \cdot WD ) = 33.0 \; 03 \qquad ( 3 )$$

$$( Second state ) D / ( {NA}^{2} \cdot WD ) = 34.059 \qquad ( 3 )$$

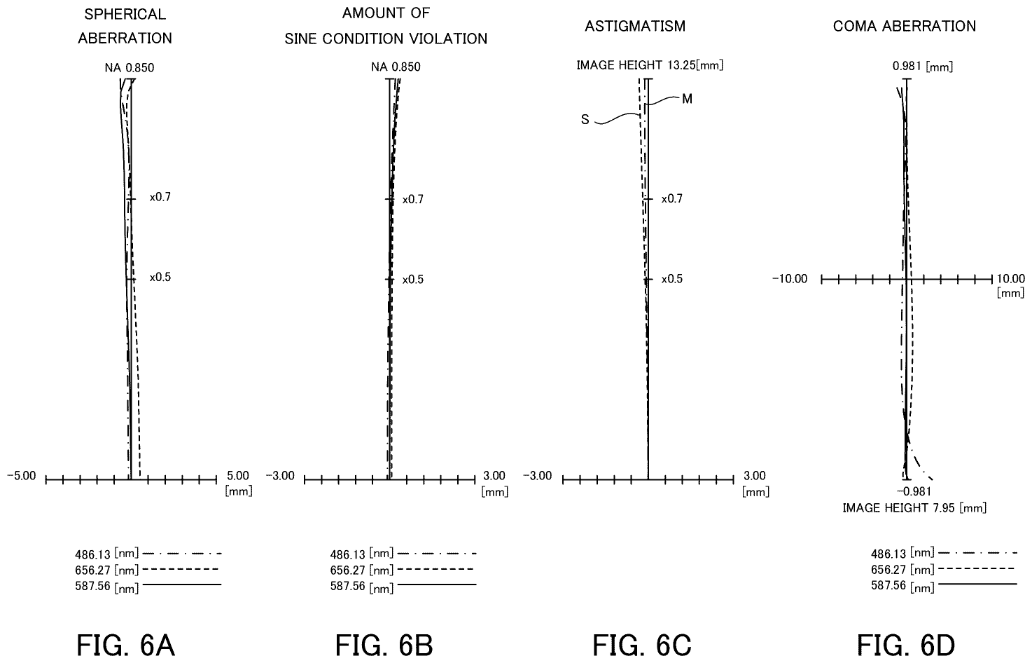

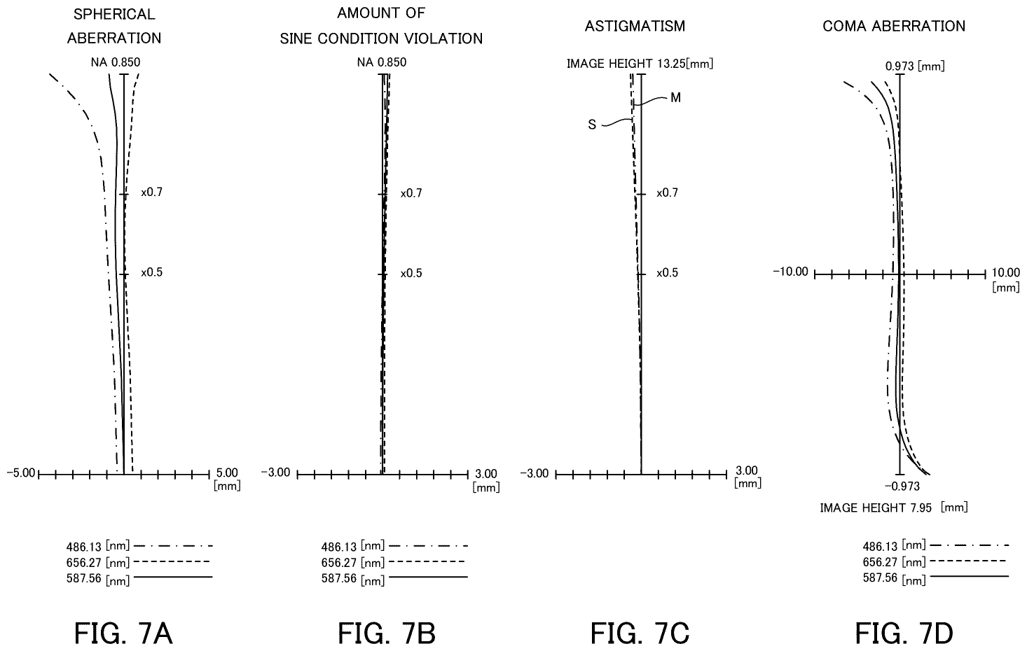

FIGS. 6 to 7 are aberration diagrams of the optical system including the objective 2 and the imaging lens 10, and illustrate aberrations on an image surface formed by the objective 2 and the imaging lens 10, in the first state and the second state, respectively. FIGS. 6A and 7A are diagrams of spherical aberrations. FIGS. 6B and 7B are diagrams illustrating the amounts of sine condition violation. FIGS. 6C and 7C are astigmatism diagrams. FIGS. 6D and 7D are diagrams illustrating coma aberrations at an image height ratio of 0.6 (image height of 7.95 mm). As illustrated in FIGS. 6 and 7, in the present example, the aberration is favorably corrected regardless of the immersion liquid.

What is claimed is:

1. An objective comprising, in order from an object side:
a first lens group having positive refractive power and including three or more lens components;
a second lens group having a highest light ray height and moving on an optical axis;
a third lens group including a lens component having a concave surface facing an image side and closest to the image side of the third lens group; and
a fourth lens group including a lens component having a concave surface facing an object side and closest to the object side of the fourth lens group, wherein
the first lens group includes a cemented lens closer to the image side than the lens component closest to the object side of the first lens group.

2. The objective according to claim 1, wherein
the lens component closest to the object side of the first lens group is a cemented lens including a positive lens with a convex surface facing the image side and a meniscus lens with a concave surface facing the object side.

3. The objective according to claim 1, wherein
the fourth lens group further includes a meniscus lens component having a concave surface facing the object side on the image side of the lens component having a concave surface facing the object side included in the fourth lens group.

4. The objective according to claim 2, wherein
the fourth lens group further includes a meniscus lens component having a concave surface facing the object side on the image side of the lens component having a concave surface facing the object side included in the fourth lens group.

5. The objective according to claim 3, wherein
the objective satisfies a following conditional expression:
$$0.002 \leq δ / D \leq 0 \text{.02} \qquad ( 1 )$$
where δ is a distance on the optical axis between the lens component and the meniscus lens component included in the fourth lens group, and D is a distance on the optical axis from a specimen surface to a lens surface closest to the image side of the fourth lens group.

6. The objective according to claim 4, wherein
the objective satisfies a following conditional expression:
$$0.002 \leq δ / D \leq 0 \text{.02} \qquad ( 1 )$$
where δ is a distance on the optical axis between the lens component and the meniscus lens component included in the fourth lens group, and D is a distance on the optical axis from a specimen surface to a lens surface closest to the image side of the fourth lens group.

7. The objective according to claim 1,
wherein the third lens group and the fourth lens group each include a cemented lens.

8. The objective according to claim 2,
wherein the third lens group and the fourth lens group each include a cemented lens.

9. The objective according to claim 1, wherein
a spherical aberration is corrected by a movement of the second lens group to a position corresponding to an immersion liquid having a refractive index of 1.33 to 1.40.

10. The objective according to claim 2, wherein
a spherical aberration is corrected by a movement of the second lens group to a position corresponding to an immersion liquid having a refractive index of 1.33 to 1.40.

11. The objective according to claim 1,
wherein the fourth lens group includes a negative refractive power.

12. The objective according to claim 2,
wherein the fourth lens group includes a negative refractive power.

13. The objective according to claim 1,
wherein the first lens group includes a three-lens cemented lens.

14. The objective according to claim 2,
wherein the first lens group includes a three-lens cemented lens.

15. The objective according to claim 1,
wherein the second lens group consists of a two-lens cemented lens.

16. The objective according to claim 2,
wherein the second lens group consists of a two-lens cemented lens.

17. The objective according to claim 1,
wherein the third lens group consists of a single lens component.

18. The objective according to claim 2,
wherein the third lens group consists of a single lens component.

19. The objective according to claim 9, wherein
the objective satisfies a following conditional expression:
$$D / f \leq 7 \qquad ( 2 )$$
$$D / ( NA 2 \cdot WD ) \leq 35 \qquad ( 3 )$$
where D is a distance on the optical axis from a specimen surface to a lens surface closest to the image side of the fourth lens group, f is a focal length of the objective, NA is a numerical aperture of the objective on the object side, and WD is a working distance of the objective.

20. The objective according to claim 10, wherein
the objective satisfies a following conditional expression:
$$D / f \leq 7 \qquad ( 2 )$$
$$D / ( NA 2 \cdot WD ) \leq 35 \qquad ( 3 )$$
where D is a distance on the optical axis from a specimen surface to a lens surface of the fourth lens group closest to the image side, f is a focal length of the objective, NA is a numerical aperture of the objective on the object side, and WD is a working distance of the objective.
